(19) United States
(12) Patent Application Publication
(10) Pub. No.: US 2006/0117800 A1
(43) Pub. Date: Jun. 8, 2006

(54) Method for manufacturing optical fiber base material

(75) Inventors: Hiroyuki Kume, Annaka-shi (JP); Tadakatsu Shimada, Annaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: SHIN-ETSU CHEMICAL CO., LTD., Tokyo (JP)

(21) Appl. No.: 11/327,399

(22) Filed: Jan. 9, 2006

Related U.S. Application Data
(63) Continuation of application No. PCT/JP04/09742, filed on Jul. 8, 2004.

(30) Foreign Application Priority Data
Jul. 10, 2003 (JP) 2003-272922

(51) Int. Cl. C03B 37/018

(52) U.S. Cl. 65/414

(57) ABSTRACT

There is provided a method for manufacturing an optical fiber base material by means of a vapor-phase axial deposition method. The method includes preparing a raw material supplying pipe that supplies raw gas centrally and a supporting gas channel and a combustion gas channel that are concentrically disposed outside the pipe, using a multiple flame burner forming a plurality of concentric flames, and generating and depositing glass particles in a state where a condition of Vᵢ<Vₘ 2Vᵢ is satisfied when linear velocity of a flow of the most inside flame is Vᵢ and linear velocity of the raw gas is Vₘ. Preferably, the condition satisfies that 1.3Vᵢ<Vₘ 1.8Vᵢ.

### CROSS REFERENCE TO THE RELATED APPLICATION

The present application is a continuation application of PCT/JP2004/009742 filed on Jul. 8, 2004, which claims priority from a Japanese Patent application No. 2003-272922 filed on Jul. 10, 2003, the entire contents of which are incorporated herein by reference for all purposes.

### BACKGROUND OF THE INVENTION

1. Field of the Invention

The present invention relates to a method for manufacturing an optical fiber base material in which glass particles generated by a flame hydrolysis reaction of frit are efficiently deposited at high speed by means of a vapor-phase axial deposition method.

2. Description of Related Art

The method for manufacturing an optical fiber base material includes, e.g., a vapor-phase axial deposition method. However, the vapor-phase axial deposition method is a method of depositing glass particles generated by a flame hydrolysis reaction of raw gas on a starting member pulled up while rotating in order to form a porous base material, and sintering and transparently vitrifying the base material to obtain a base material ingot. The base material ingot is further elongated to have a shape and a size suited for the formation of optical fiber, in order to be an optical fiber base material (a preform).

The vapor-phase axial deposition method is, as shown in FIG. 1, a method of depositing glass particles generated by a flame hydrolysis reaction of frit on a target rod 2 hung down in a chamber 1, in order to form a porous base material 3. The target rod 2 is attached to a drive unit not shown to go up while rotating. A burner for core formation 4 is provided at a point of the target rod 2 or the porous base material 3 synthesized sequentially, and a burner for cladding formation 5 is provided in the vertically upper direction thereof.

Each burner is connected to a frit (SiCl₄, GeCl₄, etc.) feeder, a combustion gas (H₂, etc.) feeder, and a supporting gas (O₂, etc.) feeder, which are not shown. Moreover, an exhauster 6 is provided on the opposite side of the burners 4 and 5 while holding the target rod 2 therebetween.

In the chamber 1, the frit, the combustion gas, and the supporting gas are ejected from the burners 4 and 5 toward the target rod 2, the frit reacts to flames 7 and 8 by means of a flame hydrolysis reaction to generate glass particles, and the glass particles are deposited and attached on the target rod 2 to form the porous base material 3. The residual glass particles, which are not deposited and attached, are exhausted outside the system by the exhauster 6.

There is now demanded the reduction of a manufacture cost in relation to an optical fiber base material. Therefore, there is urgently demanded the development of a method for manufacturing the base material efficiently and massively without losing an optical characteristic. More particularly, with respect to the need of price-reduction of an optical fiber, if a large-scale optical fiber base material can be produced at high speed, the effect is extremely large.

In a vapor-phase axial deposition method, in order to synthesize a large-scale optical fiber base material at high speed, it is necessary to increase a generation amount of glass particles to be deposited. For this purpose, there is proposed a method of improving reaction efficiency of frit and multiplexing a flame for reaction. See, for example, a Japanese Utility Model Application publication No. 57-65930 and a Japanese Patent Application Publication No. 57-27935.

That is, the method is a method of generating a flame multiply and concentrically by means of a multiple flame burner, protecting an inside flame by retreating the inside flame relative to an outside flame, and augmenting the particle size of glass particles to be generated by augmenting effective flame length.

FIG. 2 is a schematic vertical cross-sectional view showing construction of a double flame burner as an example of such a multiple flame burner.

A frit supplying pipe is arranged in the center of the burner, and frit is supplied from a frit supplying port 11. A combustion gas supplying pipe and a supporting gas supplying pipe are multiply arranged to surround the frit supplying pipe, and thus combustion gas is supplied from a combustion gas supplying port for inside flame 12 and supporting gas is supplied from a supporting gas supplying port for inside flame 13. Furthermore, combustion gas and supporting gas are respectively supplied from a combustion gas supplying port for outside flame 14 and a supporting gas supplying port for outside flame 15, and thus a double flame is formed.

In addition, there is a channel through which inert gas is supplied. However, its description will be omitted.

As shown in FIG. 2, since there is used a double flame burner in which a gas channel edge of an inside flame 16 is retreated by a distance L more behind than a gas channel edge of an outside flame 17, it is possible to protect the inside flame by the outside flame, prevent the diffusion of flame, and augment effective flame length.

When the flame length of inside flame increases, an amount of sediment of glass particles increases. That is, since hydrolysis reaction of frit is accelerated by lengthening a flame, residence time of glass particles in the flame is extended. In this way, the growth of the generated glass particles is advanced and particle size becomes large, and thus sedimentary efficiency increases.

Therefore, since a multiple flame burner in which an inside burner is retreated is used, it is possible to realize the improvement of a sedimentation rate and achieve the speedup of a synthesis rate of an optical fiber base material.

A Japanese Patent Application Publication No. 61-186239 is nominated as a well-known technique using a multiple flame burner. The publication discloses the relation between linear velocity of frit and linear velocity of a flame in relation to sedimentary efficiency. Furthermore, the publication discloses that combustion is performed to satisfy the following conditions in order to raise sedimentary efficiency when linear velocities of flames in a multiple flame are sequentially V₁, V₂, . . . , the linear velocity of the k-th flame is Vₖ, and the linear velocity of the k+1st flame on the outside is Vₖ₊₁. In addition, Vₘ is linear velocity of raw gas.

| 0.1 Vₖ₊₁ | | | Vₖ | 2.5 Vₖ₊₁ |
|---|---|---|---|---|
| | Vₘ | Vₖ₊₁ | | |
| | Vₘ | Vₖ | | |

### SUMMARY OF THE INVENTION

Therefore, it is an object of the present invention to provide a method for manufacturing an optical fiber base material in which glass particles generated by a vapor-phase axial deposition method can efficiently be deposited at high speed and a porous base material can stably be grown.

According to the present invention, there is provided a method for manufacturing an optical fiber base material by means of a vapor-phase axial deposition method. The method for manufacturing an optical fiber base material includes: preparing a raw material supplying pipe that supplies raw gas centrally and a supporting gas channel and a combustion gas channel that are concentrically disposed outside the pipe; using a multiple flame burner forming a plurality of concentric flames; and generating and depositing glass particles in a state where a condition of Vᵢ<Vₘ 2Vᵢ, preferably 1.3Vᵢ<Vₘ 1.8Vᵢ, is satisfied when linear velocity of a flow of the most inside flame is Vᵢ and linear velocity of the raw gas is Vₘ.

In the multiple flame burner, channel edges of frit and combustion gas and supporting gas of an inside flame may be provided behind channel edges of combustion gas and supporting gas of a flame outside the inside flame.

The summary of the invention does not necessarily describe all necessary features of the present invention. The present invention may also be a sub-combination of the features described above.

According to the present invention, since an amount of sediment of glass particles can be improved and a large-scale porous base material can stably be produced at high speed by setting linear velocity of frit at higher speed than that of the most inside flame and thus staying the glass particles near a sedimentary surface in high density, production efficiency is improved and a manufacture cost of an optical fiber is reduced.

### BRIEF DESCRIPTION OF THE DRAWINGS

FIG. 1 is a schematic cross-sectional view briefly explaining synthesis of a porous base material using a vapor-phase axial deposition method.

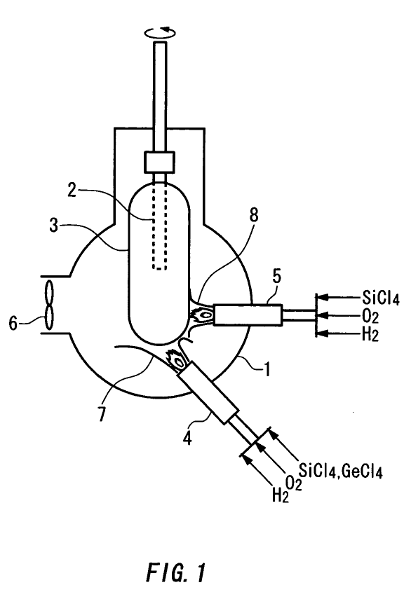

FIG. 2 is a schematic cross-sectional view of a double flame burner shown as an example of a multiple flame burner according to the present invention.

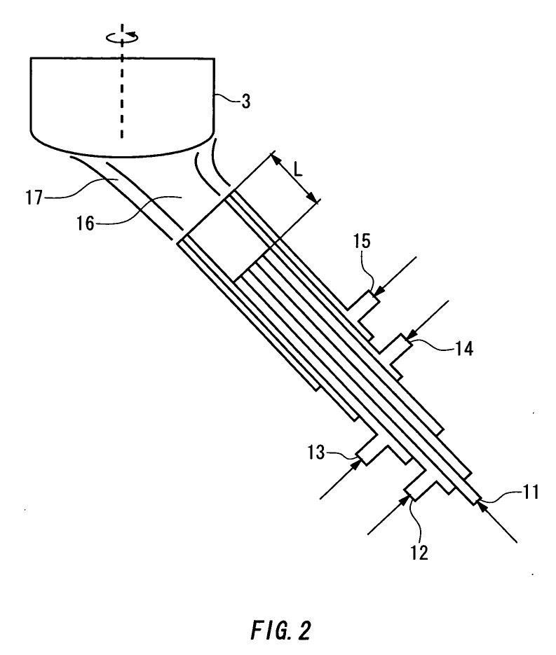

FIG. 3 is a schematic view showing the double flame burner that is used in an embodiment.

FIG. 4 is a characteristic view showing correlativity between a ratio of linear velocity of frit to linear velocity of an inside flame and a sedimentation rate.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

According to a Japanese Patent Application Publication No. 61-186239, when linear velocity Vₘ of raw gas is changed by changing flow volume of carrier gas, in order to raise a yield of glass particles, a flow of double flame requires a condition of Vₘ Vₒ, preferably Vₘ Vₒ=Vᵢ, for example when linear velocity of a flow of outside flame is Vₒ and linear velocity of a flow of inside flame is Vᵢ.

The yield of glass particles is maximum when Vₘ=Vᵢ. However, in case of Vₘ>Vₒ and Vₘ>Vᵢ, frit hardly reacts to a flame and thus a porous base material is not grown stably.

However, in order to be able to synthesize a porous base material at high speed, it is necessary to raise a sedimentation rate and stably grow the porous base material. In this relation, the inventors of the present application found that the improvement of a real sedimentation rate is more important than a yield of glass particles. Furthermore, the inventors focused attention on linear velocity Vᵢ of the most inside flame flow from a plurality of flame flows formed by the multiple flame burner and found that the porous base material can stably be grown at higher speed than that of the conventional condition of Vₘ Vᵢ under a condition of Vₘ>Vᵢ.

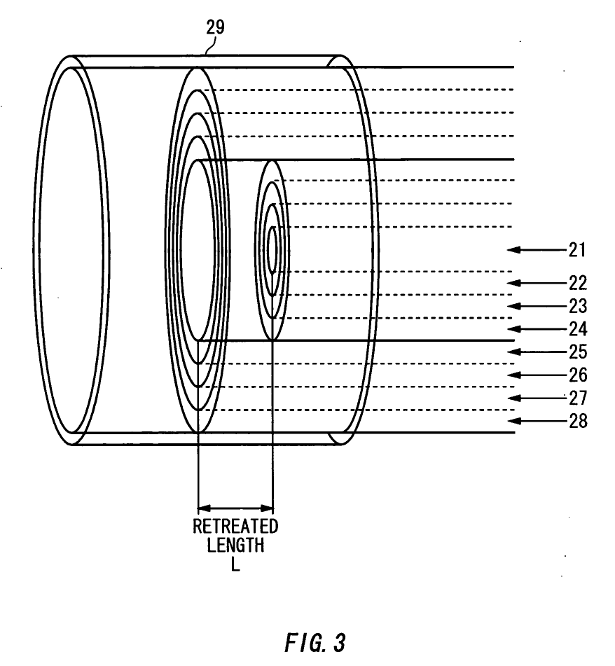

FIG. 3 is a schematic cross-sectional view showing construction of a double flame burner shown as an example of a multiple flame burner that is used in a method for manufacturing an optical fiber base material according to an embodiment of the present invention.

In FIG. 3, gas channels are concentrically formed with a central focus on a frit supplying pipe 21. The frit supplying pipe 21 is supplied with frit such as SiCl₄ and GeCl₄ along with carrier gas such as Ar, and O₂. A combustion gas channel 22 is supplied with H₂, hydrocarbon, etc., an inert gas channel 23 is supplied with Ar, He, N₂, etc., and a supporting gas channel 24 is supplied with O₂ etc. The inside flame is formed from these combustion gas and supporting gas.

Furthermore, the outside flame is formed from combustion gas and supporting gas supplied from an inert gas channel 25, a combustion gas channel 26, an inert gas channel 27, and a supporting gas channel 28. These channel edges are protected by a burner cover 29.

In addition, a gas channel edge for inside flame is retreated by length (retreated length) L behind a gas channel edge for outside flame.

Next, by means of the double flame burner, there was performed a test of checking a sedimentation rate of glass particles while changing linear velocity of frit.

The linear velocity of frit was changed by constantly holding the linear velocity Vᵢ of the inside flame as 1.2 m/s and the linear velocity Vₒ of the outside flame as 0.33 m/s and changing an inside diameter of a raw material supplying pipe or flow volume of carrier gas. The porous glass base material was synthesized while changing a supplied amount of frit so that a position of a point of the porous glass base material formed by the deposition of glass particle does not go up and down and climbing speed is constant.

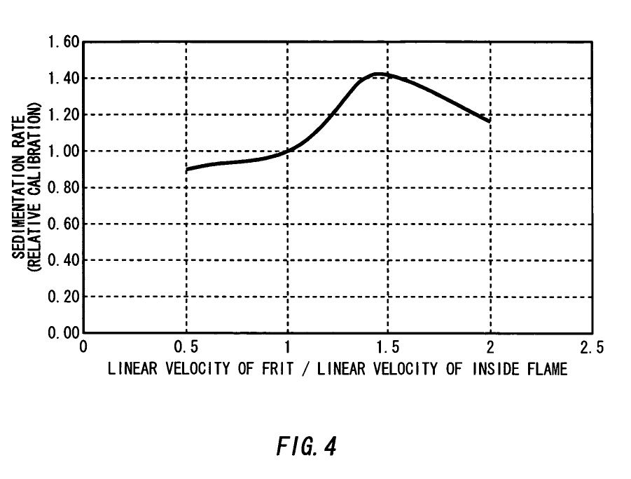

FIG. 4 is a graph showing relation between the linear velocity of frit to a flow of the obtained inside flame and the sedimentation rate. In addition, the sedimentation rate was computed by weighing the porous glass base material after terminating synthesis and dividing the weight by sedimentary time. A numeric value of the sedimentation rate on a vertical axis is a relative value in which the sedimentation rate is one when a ratio of [linear velocity of frit/linear velocity of inside flame] is one.

In FIG. 4, as the linear velocity of frit Vₘ increases relatively, it is admitted that the sedimentation rate increases. When Vₘ further becomes large and thus Vₘ/Vᵢ exceeds about 1.5, the sedimentation rate falls adversely and thus a sedimentation rate in Vₘ=2Vᵢ was substantially equal to a sedimentation rate in Vₘ=1.1Vᵢ. Since the sedimentary efficiency when 1.3 Vₘ/Vᵢ 1.8 is 1.3 times greater than efficiency when Vₘ/Vᵢ=1, it is possible to synthesize a porous base material at high speed.

When flow velocity of the inside flame and the outside flame is changed, the same tendency as that of FIG. 4 was obtained. The reason that the diffusion of glass particles in a flame is controlled, the glass particles exist near a sedimentary surface in high density, and an amount of sediment of glass particles increases due to a thermophoresis effect, by setting the linear velocity of frit more quickly than that of a flow of the inside flame.

When the linear velocity of frit increases further, it is considered that residence time of the glass particles near the sedimentary surface decreases and thus an amount of sediment decreases.

In this manner, a sedimentation rate is important for high-speed synthesis of a porous base material, and the sedimentation rate improves in the range of Vᵢ<Vₘ 2Vᵢ.

The linear velocity of frit, the linear velocity of inside flame, and the linear velocity of outside flame can also be adjusted by changing flow volume of combustion gas and supporting gas besides changing an inside diameter and an outside diameter of concentric channels and flow volume of carrier gas.

In that case, as described above, it is important that the linear velocity Vₘ of frit and the linear velocity Vᵢ of inside flame is adjusted so that Vi<Vm 2Vi, preferably 1.3Vi Vm 1.8Vi is satisfied, and thus and a porous base material can stably be grown at high speed relative to Vₘ Vᵢ.

In this way, since the linear velocity of frit is higher speed than that of the most inside flame flow in a multiple flame, the diffusion of glass particles in the flame can be controlled, the glass particles can exist near a sedimentary surface in high density, and an amount of sediment of the glass particles can be increased by a thermophoresis effect.

At this time, since a multiple flame burner having a retreated inside flame is used, the inside flame can be protected by an outside flame, the diffusion of the inside flame can be prevented, substantially effective length of the inside flame can increase, frit can fully be reacted, particle size of glass particles can increase, and reaction efficiency of raw material can increase.

### EMBODIMENT 1

The porous base material was synthesized using the double flame burner having a burner outside diameter of 50 mm and retreated length of 35 mm shown in FIG. 3.

The frit supplying pipe 21 of a burner for core formation is supplied with SiCl₄ of 1200 mL/min and GeCl₄ of 80 mL/min using O₂ as a carrier. Moreover, the combustion gas channels 22 and 26 are supplied with H₂, the inert gas channels 23, 25, and 27 are supplied with Ar, and the supporting gas channels 24 and 28 are supplied with O₂. The linear velocity Vₘ of frit and the linear velocity Vᵢ of inside flame and the linear velocity Vₒ of outside flame of a burner for core formation are respectively set to 2.17 m/s, 1.31 m/s, and 0.33 m/s in sequence, by adjusting the inside diameter of the frit supplying pipe 21.

Under such a condition (Vₘ=1.66Vᵢ), the deposition of glass particles is stably performed at high speed and the velocity of core formation was 52.3 g/h. There was obtained a large-scale porous base material having a stable step-index type profile in a longitudinal direction and effective length of 800 mm.

### COMPARATIVE EXAMPLE 1

The porous base material was synthesized in a state where the linear velocity of frit is approximately equal to the linear velocity of inside flame.

The frit supplying pipe of the burner for core formation is supplied with SiCl₄ of 750 mL/min and GeCl₄ of 50 mL/min using O₂ as a carrier. The linear velocity Vₘ of frit and the linear velocity Vᵢ of inside flame and the linear velocity Vₒ of outside flame of the burner for core formation are respectively set to 1.20 m/s, 1.20 m/s, and 0.33 m/s in sequence, by adjusting the inside diameter of the frit supplying pipe.

Under such a condition (Vₘ=Vᵢ), the deposition of glass particles was stably performed. However, the velocity of core formation was 38.6 g/h.

Although the present invention has been described by way of an exemplary embodiment, it should be understood that those skilled in the art might make many changes and substitutions without departing from the spirit and the scope of the present invention. It is obvious from the definition of the appended claims that embodiments with such modifications also belong to the scope of the present invention.

What is claimed is:

1. A method for manufacturing an optical fiber base material by means of a vapor-phase axial deposition method, comprising:
preparing a raw material supplying pipe that supplies raw gas centrally and a supporting gas channel and a combustion gas channel that are concentrically disposed outside the pipe;
using a multiple flame burner forming a plurality of concentric flames; and
generating and depositing glass particles in a state where a condition of Vᵢ<Vₘ 2Vᵢ is satisfied when linear velocity of a flow of the most inside flame is Vᵢ and linear velocity of the raw gas is Vₘ.

2. The method for manufacturing an optical fiber base material as claimed in claim 1, wherein said generating glass particles comprises generating glass particles in a state where a condition of 1.3Vᵢ<Vₘ 1.8Vᵢ is satisfied.

3. The method for manufacturing an optical fiber base material as claimed in claim 1, wherein in the multiple flame burner, channel edges of frit and combustion gas and supporting gas of an inside flame are provided behind channel edges of combustion gas and supporting gas of a flame outside the inside flame.

4. The method for manufacturing an optical fiber base material as claimed in claim 2, wherein in the multiple flame burner, channel edges of frit and combustion gas and supporting gas of an inside flame are provided behind channel edges of combustion gas and supporting gas of a flame outside the inside flame.
